(19) United States
(12) Patent Application Publication
(10) Pub. No.: US 2016/0277073 A1
(43) Pub. Date: Sep. 22, 2016

(54) Object Identification and Weight

(71) Applicant: Robert Charles Schwendinger, Southlake, TX (US)

(72) Inventor: Robert Charles Schwendinger, Southlake, TX (US)

(21) Appl. No.: 15/073,614

(22) Filed: Mar. 17, 2016

Related U.S. Application Data
(60) Provisional application No. 62/135,019, filed on Mar. 18, 2015.

(51) Int. Cl. H04B 5/00; G01G 3/00; H04W 4/00

(52) U.S. Cl. CPC H04B 5/0062; H04W 4/008; G01G 3/00

(57) ABSTRACT

The Object Identification and Weight device is a thin layer pad that can capture an object's current identification and weight. The device will return the real-time object's identification and weight when the object (with a pre-configured NFC tag) is placed on the device (pad). This is accomplished by the combination of the layered NFC Loop-Inductor Antenna and NFC Radio with a thin membrane utilized to measure weight and a processor. The NFC Radio is able to capture pre-defined information from the NFC tag on the object. Weight captured by the thin membrane is then calculated and incorporated through the processor with the NFC tag information to provide real-time accurate information of the object.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of “Internet of Things” providing real-time updates to personal electronic devices (PCs, Mobile, Tablet, Watches, and Glasses). More particularly, the present invention is in the technical field of communications utilizing RFID specifically Near Field Communications (NFC) to identify and communicate status of objects by use of pressure pads.

To date, most electronic interactions with objects, like grocery products, warehouse inventory, and tracking has been in the use of barcode, QR Code, large RFID and other digital scanning solutions.

### SUMMARY OF THE INVENTION

The present invention is a thin membrane electronic scale with the ability not only to weigh an object but to communicate a predefined object electronic tag with current weight to a preselected device.

### BRIEF DESCRIPTION OF THE DRAWINGS

FIG. 1 is a perspective view of the Object Identification and Weight device of the present invention.

### DETAILED DESCRIPTION OF THE INVENTION

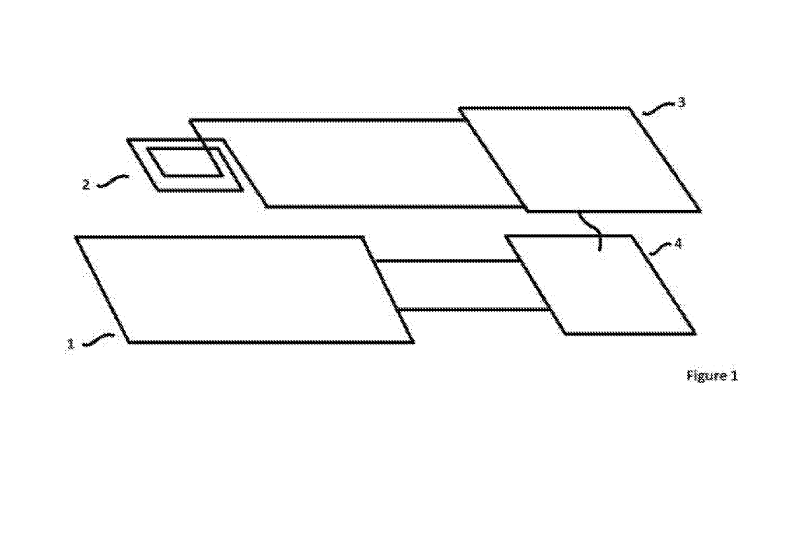

Referring now to the invention in more detail, in FIG. 1 there is shown a layered configuration of the thin membrane 1 and processor 4 with the NFC Loop-Inductor Antenna 2 and NFC Radio 3. The thin membrane 1 is utilized to measure weight and connects to the Processor 4 to calculate weight. The NFC Loop-Inductor Antenna 2 is directly connected to the NFC Radio 3. The NFC Radio 3 connects to the Processor 4 to provide object identification.

In more detail, still referring to the invention of FIG. 1, the upper NFC Loop-Inductor Antenna 2 and NFC Radio 3 are layered on the thin membrane 1 and processor 4 providing an extremely thin pad.

In further detail, still referring to the invention of FIG. 1, when an object with an NFC tag is placed on the pad (combination of the layered NFC Loop-Inductor Antenna 2 and NFC Radio 3 with the thin membrane 1 and processor 4), the NFC Radio 3 is able to capture pre-defined information from the NFC tag on the object. Weight captured by the thin membrane 1 is then calculated and incorporated with the NFC tag information through the processor 4 to provide real-time accurate information of the object.

The advantages of the present invention include, without limitation, the ability to allow an object to be identified and weight to be determined real-time, providing instantaneous statistics of items being monitored.

The present invention is an incorporation of a thin membrane utilized for measuring weight and a NFC radio integrated with a processor that can identify the object placed on its surface and determine the current weight.

I claim:

1. Ability to capture RFID (NFC) tagged object(s) identification with wireless communications through RFID technology, specifically NFC (Near Field Communications).

2. Ability to capture weight of the identified object(s) by use of a thin membrane to measure weight.

3. Ability to use the object(s) identification captured by RFID (NFC) communications and the weight captured through the use of a thin membrane to provide the real-time data of the object(s) information.
